(19) United States
(12) Patent Application Publication
(10) Pub. No.: US 2022/0215107 A1
(43) Pub. Date: Jul. 7, 2022

(54) SYSTEM AND METHODS TO PERFORM ROW LEVEL FIELD MASKING LEVERAGING ATTRIBUTE BASED ACCESS CONTROL IN A MULTI TENANT ENVIRONMENT

(71) Applicant: salesforce.com, inc., San Francisco, CA (US)

(72) Inventors: Mang Fu Matthew Wong, Castro Valley, CA (US); Yanik Grignon, Georgetown, TX (US); Larry H Tung, Alameda, CA (US); Peter S. Wisnovsky, Oakland, CA (US)

(73) Assignee: salesforce.com, inc., San Francisco, CA (US)

(21) Appl. No.: 17/144,035

(22) Filed: Jan. 7, 2021

(51) Int. Cl. G06F 21/62; G06F 16/2455; G06F 16/28; G06F 21/60

(52) U.S. Cl. CPC G06F 21/6209; G06F 16/24565; G06F 2221/2141; G06F 21/604; G06F 16/285

(57) ABSTRACT

A computer implemented masking manager provides a method for access controls. The method includes receiving a request for an object in a database, retrieving the object from the database, applying masking rules to a field of the object to determine whether the requestor has access to the field, determining a replacement value for the field based on requestor access to the field, and returning the object to the requestor with the replacement value in the field of the object.

### TECHNICAL FIELD

One or more implementations relate to the field of database management; and more specifically, to processes and apparatus for row level access controls.

### BACKGROUND ART

A database is an organized collection of data that is stored in a machine-readable medium. The data can be accessed from the machine-readable medium by various types of electronic devices. The data collection, or data set, can have any organization or structure. The amount of data that can be managed by the database can vary depending on the limitations of the machine-readable medium, and the software utilized to manage the data set.

The software for managing the data set can be referred to as a database management system (DBMS). The DBMS interacts with users of the database, applications, and the database itself to store, process, and retrieve the data set. The DBMS software also includes basic functions to administer the database, such as configuration tools, data processing functions, and similar functions. The combination of the database, the DBMS, and the associated applications and processes, can be referred to as a ‘database system.’ The term “database” is also commonly used to refer to any combination of the DBMS, the database itself, the database system, or applications associated with the database system.

Database-management systems can be classified based on the database model that they support or implement. Relational databases or derivatives thereof are in common usage. The relational databases and other types of databases model or organize the data set as rows and columns in a set of tables. Most database systems utilize a formal query language such as the structured query language (SQL) or similar query languages for accessing, storing, and manipulating the data set. Various types of non-relational databases are also in common use, some of which utilize different types of query languages referred to as non-SQL (NoSQL) query languages.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a diagram of one implementation of a database system.

FIG. 2 is a diagram of an example implementation of a user interface for the database system.

FIG. 3 is a flowchart of one example implementation of a process for masking data in a database.

FIG. 4 is a flowchart of one example implementation of a process for enforcing masking of data in a database.

FIG. 5A is a block diagram illustrating an electronic device according to some example implementations.

FIG. 5B is a block diagram of an environment where a masking manager may be deployed, according to some implementations.

### DETAILED DESCRIPTION

The following description describes methods and apparatus for masking row level data in a data base system. The masking process combines a rule based system that allows for describing matching rows and access controls with a system for designating specific fields in records or objects tied to the rules to describe the visibility of the particular fields for an organization. Fields that are masked in this way can initiate a check of a user permission level to check whether a user has access to the masked field. In some implementations, queries for retrieving data that includes masked fields from a data base can be implemented as a set of clause filters, which are converted on the fly to assembled case statements. These case statements can be augmented into a result set as an artificial column. The result set can be processed on the end result of the per row values of the case column.

The term “user” is a generic term referring to an entity (e.g., an individual person) using a system and/or service. A multi-tenant architecture provides each tenant with a dedicated share of a software instance and the ability (typically) to input tenant specific data for user management, tenant-specific functionality, configuration, customizations, non-functional properties, associated applications, etc. Multi-tenancy contrasts with multi-instance architectures, where separate software instances operate on behalf of different tenants. A tenant includes a group of users who share a common access with specific privileges to a software instance providing a service. A tenant may be an organization (e.g., a company, department within a company, etc.). A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third party application developers providing applications/services and another set of tenants may be customers of different ones or all of the third-party application developers. A user may have one or more roles relative to a system and/or service. To provide some examples, a user may be a representative (sometimes referred to as an “end user”) of a tenant (e.g., a vendor or customer), a representative (e.g., an administrator) of the company providing the system and/or service, and/or a representative (e.g., a programmer) of a third-party application developer that is creating and maintaining an application(s) on a Platform as a Service (PAAS).

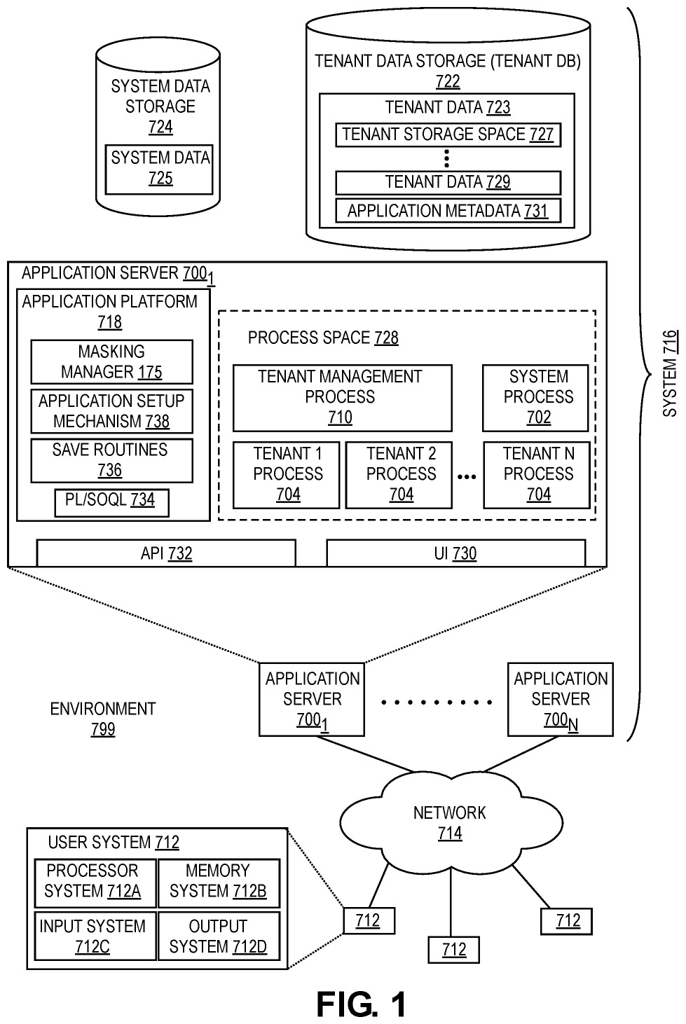

FIG. 1 is a block diagram of an environment in which a database service may operate in accordance with the described embodiments. User system 112 may include a processor system 112A, memory system 112B, input system 112C, and output system 112D. FIG. 1 shows network 114 and system 116. FIG. 1 also shows that system 116 may include tenant data storage 122, having therein tenant data 123, which includes, for example, tenant storage space 127, tenant data 129, and application metadata 131. System data storage 124 is depicted as having therein system data 125. Further depicted within the expanded detail of application servers 1001-N are User Interface (UI) 130, Application Program Interface (API) 132, application platform 118 includes PL/SOQL 134, save routines 136, application setup mechanism 138, process space 128 includes system process space 102, tenant 1-N process spaces 104, and tenant management process space 110. In other embodiments, environment 199 may not have the same elements as those listed above and/or may have other elements instead of, or in addition to, those listed above.

User system 112, network 114, system 116, tenant data storage 122, and system data storage 124 are shown by FIG. 1, system 116 may include a network interface 120 implemented as a set of HTTP application servers 100, an application platform 118, tenant data storage 122, and system data storage 124. Also shown is system process space 102, including individual tenant process spaces 104 and a tenant management process space 110. Each application server 100 may be configured to tenant data storage 122 and the tenant data 123 therein, and system data storage 124 and the system data 125 therein to serve requests of user systems 112. The tenant data 123 might be divided into individual tenant storage areas (e.g., tenant storage space 127), which may be either a physical arrangement and/or a logical arrangement of data. Within each tenant storage space 127, tenant data 129, and application metadata 131 might be similarly allocated for each user. For example, a copy of a user's most recently used (MRU) items might be stored to tenant data 129. Similarly, a copy of MRU items for an entire organization that is a tenant might be stored to tenant storage space 127. A UI 130 provides a user interface and an API 132 provides an application programmer interface into system 116 resident processes to users and/or developers at user systems 112. The tenant data and the system data may be stored in various databases, such as one or more Oracle™ databases.

Application platform 118 includes an application setup mechanism 138 that supports application developers' creation and management of applications, which may be saved as metadata into tenant data storage 122 by save routines 136 for execution by subscribers as one or more tenant process spaces 104 managed by tenant management process space 110 for example. Invocations to such applications may be coded using PL/SOQL 134 that provides a programming language style interface extension to API 132. Invocations to applications may be detected by one or more system processes, which manages retrieving application metadata 131 for the subscriber making the invocation and executing the metadata as an application in a virtual machine.

Each application server 100 may be communicably coupled to database systems, e.g., having access to system data 125 and tenant data 123, via a different network connection. For example, one application server 1001 might be coupled via the network 114 (e.g., the Internet), another application server 100N-1 might be coupled via a direct network link, and another application server 100N might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 112 to distribute requests to the application servers 100. In one embodiment, the load balancer uses a least connections algorithm to route user requests to the application servers 100. Other examples of load balancing algorithms, such as round robin and observed response time, also may be used. For example, in certain embodiments, three consecutive requests from the same user may hit three different application servers 100, and three requests from different users may hit the same application server 100. In this manner, system 116 is multi-tenant, in which system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a multi-tenant system (MTS) arrangement, since all of the data and the applications to access, view, modify, report, transmit, calculate, etc., may be maintained and accessed by a user system having nothing more than network access, the user may manage his or her sales efforts and cycles from any of many different user systems. For example, if a salesperson is visiting a customer and the customer has Internet access in their lobby, the salesperson may obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 816 might also maintain system level data usable by multiple tenants or other data. Such system level data might include industry reports, news, postings, and the like that are sharable among tenants.

In certain embodiments, user systems 112 (which may be client systems) communicate with application servers 100 to request and update system-level and tenant-level data from system 116 that may require sending one or more queries to tenant data storage 122 and/or system data storage 124. System 116 (e.g., an application server 100 in system 116) automatically generates one or more SQL statements (e.g., one or more SQL queries) that are designed to access the desired information. System data storage 124 may generate query plans to access the requested data from the database.

Each database may generally be viewed as a collection of objects, such as a set of logical tables, containing data fitted into predefined categories. A “table” is one representation of a data object, and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

In some implementations, the data base system can include a masking manager 175 that operates in conjunction with other access control systems (not shown) to manage user access to specific fields of data base records and objects. The masking manager can utilize attribute based access control (ABAC) and/or similar access control functions to implement user specific masking. ABAC and similar access control systems manage access to data based on a value or attribute of a record or object as it relates to a current contextual user performing an action on the record or object. Row level field masking using ABAC or similar access control enable a value or attribute of record or object, in conjunction with rules defined in an organization by an administrator, to control whether a particular user can or cannot see specified fields on that particular record.

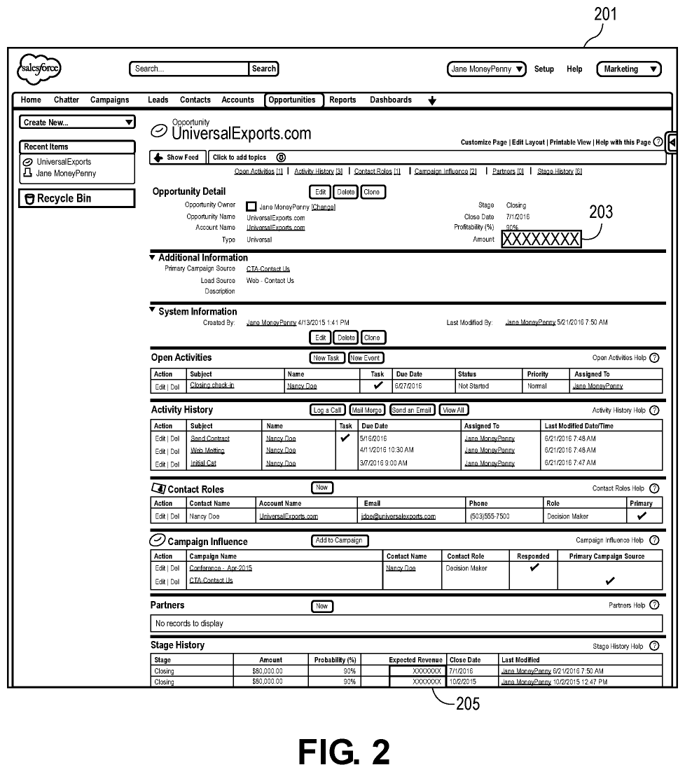

FIG. 2 is a diagram of an example implementation of a user interface for accessing records in a data base system. A typical ordering of events is described to illustrate the masking functionality. In this example there is a business and security need to make it so that certain fields are hidden or be made invisible at the row level based on rules for the row and the user doing the viewing. In other words, based on the relationship between a value on the row and the current user, the applicable rules will decide if some fields should be visible by this user. A few examples can include a case where the record has a manager field. If the record's manager is the current user, the current user should be able to see the address field. In another example, the record has an owner field. If the record's owner is the current user, the current user should be able to see all the fields, otherwise, the current user should only see a subset of the fields.

In the example of FIG. 2, a sales opportunity record 201 is shown. The user, Jane Moneypenny, is a salesperson working on the sales opportunity. However, certain fields are restricted to manager level and are therefore masked (shown ‘xxxxx’). In this example, the user does not have permissions for viewing revenues associated with the sales, thus, the amount 203 and the expected revenues 205 associated with the displayed record are masked and not visible to the user, although they remain a part of the record and viewable by users with the correct permissions.

This example can be established by an administrator of the organization of the user. The administrator, based on the business need, can tag fields that need to behave in this manner to designate that such fields need such visibility configured. The administrator can create corresponding classification categories (e.g., PII) and classify fields to such categories to signal that such fields need to participate in field masking. The administrator configures the classifications as participating in row level field visibility.

In some implementations, an administrator can use an interface with multi-select pick-list with data classifications that can be selected. Once a data classification is selected and enabled, records with fields with those data classifications are hidden unless the record matches a rule that grants permissions to the current user.

An administrator can create a “Field Level ABAC Rule,” or similar rules to enable viewing of masked fields in the database system. The rule can consist of the entity type in question (e.g. The Employee Object), the rule, in a formula syntax format (e.g. Employee.Manager=$User.Id), the kinds of users this rule should apply to, in formula syntax format (e.g. $User.ProfileId=‘00e . . . ’).

An administrator for an organization can also specify rules such that designated fields that need row level field visibility rules would behave in the manner that such fields would be hidden for any user interacting with records with such fields unless the user matches a rule that gives the user visibility to such fields. The rules can be organization wide Or limited to subsets of users or records associated with the organization. In some implementations, there can be system level rules as well that govern user access and masking.

A user can navigate around the records of the data base system, and encounter records of a type of entity configured with masking rules in various ways, such as through the user interface (as shown in FIG. 2), through the application programming interface (API), through report generation, or in any of the different ways that the application platform allows access to records that work on the application platform. The retrieval process of such records checks against the configuration and policies, and transforms the query to include information on whether the requested fields for each row returned should be processed to be masked when returned to the user. In this way the user sees values for fields that the user has specific permissions for and fields that should be masked are not displayed.

The developer of the application platform can build additional solutions on the basis of the masking functions. The additional solutions can interact with records that have masked fields. In order for the solution to behave properly, the solution needs to know whether it is interacting with a masked field, is the record value empty because it is a masked field, or because it really is actually null, whether the user/solution is in a privileged system mode and as such has access to every field), how to perform a post process on the record so that it matches what the user can access, and similar information. All of this information is needed to render the user experience correctly, and have the underlying logic behave correctly.

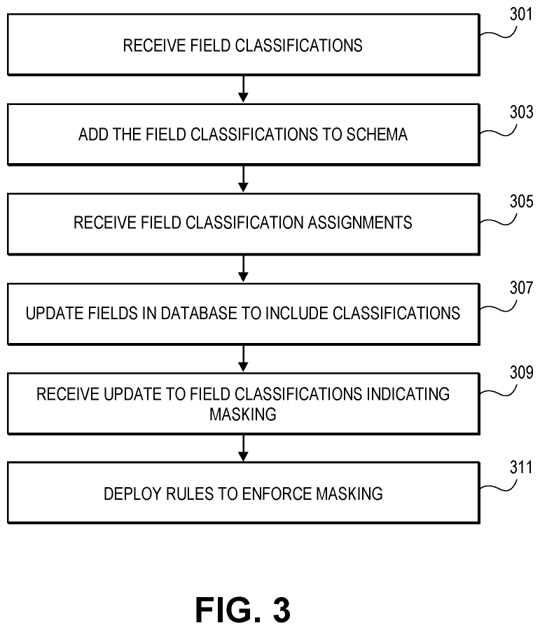

FIG. 3 is a flowchart of one example implementation of a process for designating data fields as masked. This process can be initiated by an administrator or similar user that selects a set of field classifications to utilize for an organization, record, group of records or similar set of data (Block 301). For example, a classification of a personally identifiable information (PII) can be created. The masking process can receive this set of field classifications, and add the field classification to the records design or schema (Block 303) to enable the association of the field classifications with fields of the associated records. The masking process can then receive selection of field classification assignments from an administrator or similar user (Block 305). The field classification assignments indicate which fields are given specific defined classifications. For example, a field for employee address could be assigned to be a PH.

The fields of records in the data base system are then updated with field classifications (Block 307). At any time after the field classifications are created, a user (e.g., an administrator) can designate a field classification as ‘masked’ and define rules for the masking (Block 309). For example, the fields with PIT classification can be designated as masked and a rule indicating only immediate supervisor users can unmask data in these fields. The rules are then deployed to the database system for enforcing the masking (Block 311). For example, rules can enable unmasking, using any language for rule definition, “for the employee object,’ ‘for users with permission set Y,’ and for ‘employee manager=$user.id” or similar rules syntax.

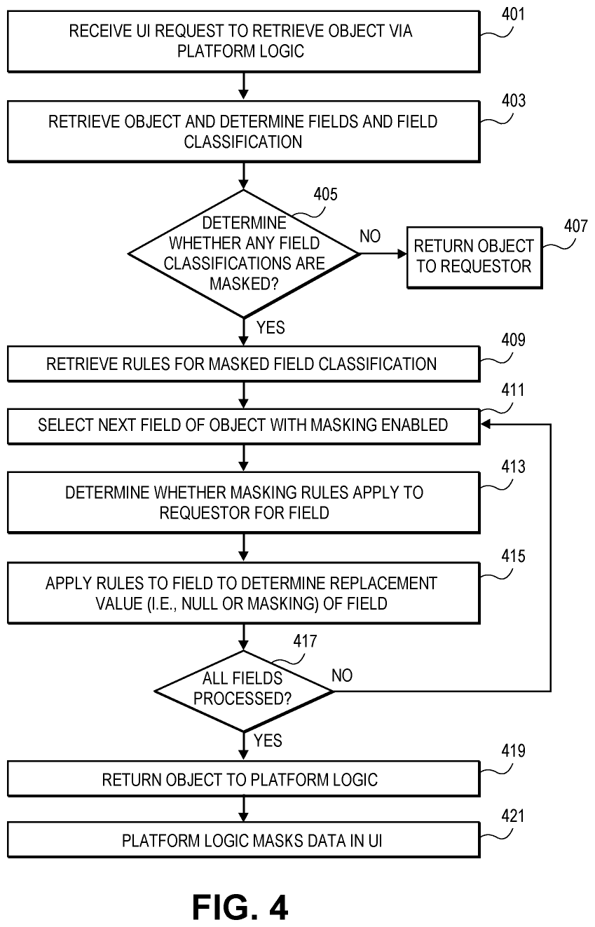

FIG. 4 is a flowchart of one example implementation of a process for evaluating whether a user can unmask a data field. The process for runtime evaluation of masks can be triggered where there is a request received by the masking manager of an object or record from a UI, API, or other source via application platform logic (Block 401). The object or record can be retrieved and the field and field classifications for the object or record can be determined (Block 403). A determination is then made whether any of the field classifications are designated as masked (Block 405). If none of the fields are classified such that masking applies, then the object can be returned to the requestor (Block 407).

If at least one field has a classification that is designated as masked, then the process evaluates the masking for the current user context. The rules that are defined for the masked field classification are retrieved (Block 409). The process then iterates through the fields of the object to evaluate the rules for each field with a masked classification. The process selects the next field of the object or record with masking enabled (Block 411). The process then determines whether the masking rules apply to the requestor for the field (Block 413). In some implementations, the rule evaluation process takes the rules tied to the object as it applies to the user, dynamically generate a CASE statement, and transforms the rule criteria into the CASE statement so that each row's circumstances are calculated per the rules. When the results are returned to the user, the extra information that is generated by the rule evaluation process is leveraged to process the result such that for each row that should be masked, the appropriate fields et masked.

More generally, the rules are applied for the field to determine whether the requestor meets the criteria for unmasking the field (Block 413). If the requestor meets the criteria, then the value can be unmasked. The rules for determining a replacement value for the masked field can also be determined where the requestor does not have the appropriate permission set (Block 415). A check can then be made whether further fields remain to be processed for the requested object, if so, then the process selects a next field to process (Block 411). If no further fields remain to be processed, then the object is return to the requestor via platform logic (Block 419). The platform logic can implement the masking of data in the user interface or via other mechanisms (Block 421).

The developer of applications for the application platform can write applications that are able to leverage the rules and masking information that the query processing augments to write properly behaving code. When developers create solutions that could potentially interact with masked data, they are able to write code that anticipates masked data. Similarly, when end users execute such code, the same masking applies, but on top of that, the code is able to interrogate for whether data is masked, which is enabled by virtue of the solution.

Exemplary Electronic Devices

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

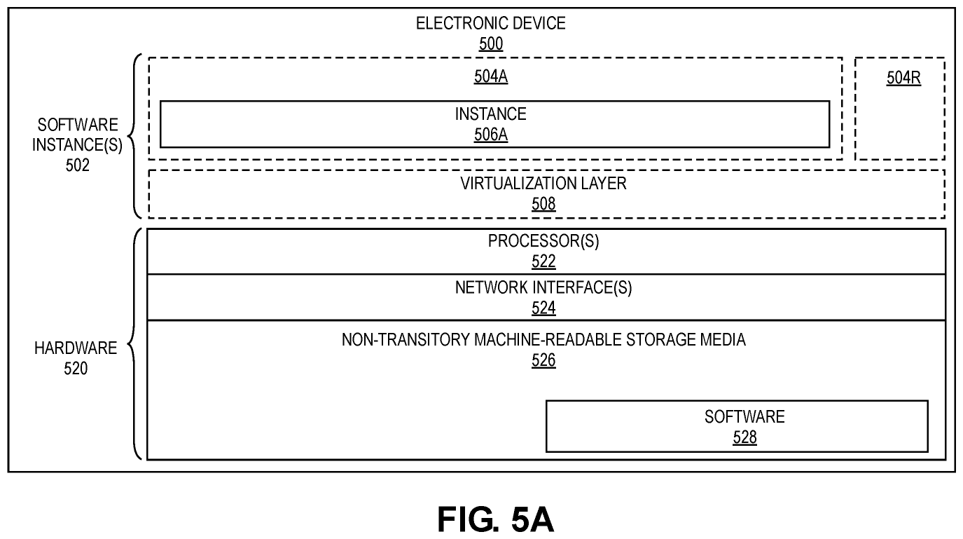

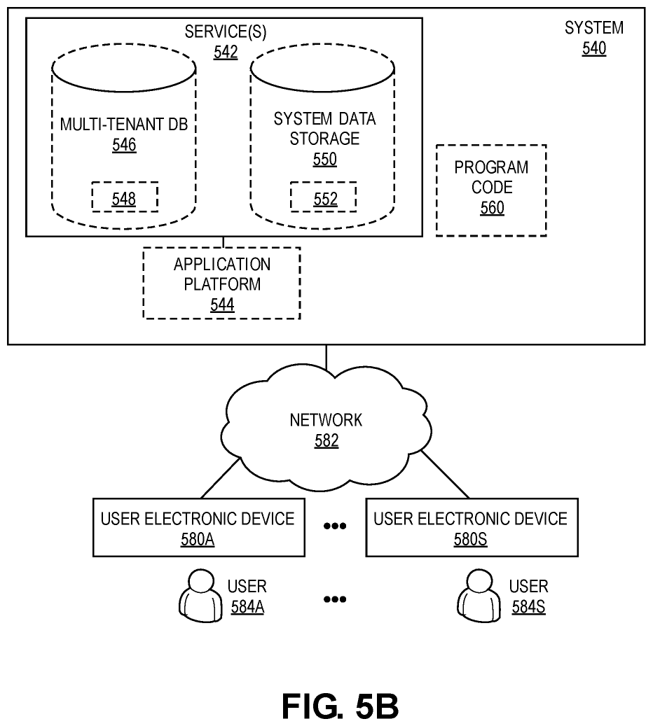

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and non-transitory machine-readable storage media 526 having stored therein software 528 (which includes instructions executable by the set of one or more processor(s) 522). Each of the previously described end user clients and the masking service may be implemented in one or more electronic devices 500. In one implementation: 1) each of the end user clients is implemented in a separate one of the electronic devices 500 (e.g., in user electronic devices operated by users where the software 528 represents the software to implement end user clients to interface with the masking service (e.g., a web browser, a native client, a portal, a command-line interface, and/or an application program interface (API) based upon protocols such as Simple Object Access Protocol (SOAP), Representational State Transfer (REST), etc.)); 2) the masking service is implemented in a separate set of one or more of the electronic devices 500 (e.g., a set of one or more server electronic devices where the software 528 represents the software to implement the masking service); and 3) in operation, the electronic devices implementing the end user clients and the masking service would be communicatively coupled (e.g., by a network) and would establish between them (or through one or more other layers) connections for submitting queries to the masking service and returning masked objects or records to the end user clients. Other configurations of electronic devices may be used in other implementations (e.g., an implementation in which the end user client and the masking service are implemented on a single electronic device 500).

In electronic devices that use compute virtualization, the set of one or more processor(s) 522 typically execute software to instantiate a virtualization layer 508 and software container(s) 504A-R (e.g., with operating system-level virtualization, the virtualization layer 508 represents the kernel of an operating system (or a shim executing on a base operating system) that allows for the creation of multiple software containers 504A-R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 528 (illustrated as instance 506A) is executed within the software container 504A on the virtualization layer 508. In electronic devices where compute virtualization is not used, the instance 506A on top of a host operating system is executed on the “bare metal” electronic device 500. The instantiation of the instance 506A, as well as the virtualization layer 508 and software containers 504A-R if implemented, are collectively referred to as software instance(s) 502.

Alternative implementations of an electronic device may have numerous variations from that described above. For example, customized hardware and/or accelerators might also be used in an electronic device.

Network Device

A network device (ND) is an electronic device that communicatively interconnects other electronic devices on the network (e.g., other network devices, user electronic devices, server electronic devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Exemplary Environment

FIG. 5B is a block diagram of an environment where a masking manager may be deployed, according to some implementations. A system 540 includes hardware (a set of one or more electronic devices) and software to provide service(s) 542, including the masking service. The system 540 is coupled to user electronic devices 580A-S over a network 582. The service(s) 542 may be on-demand services that are made available to one or more of the users 584A-S working for one or more other organizations (sometimes referred to as outside users) so that those organizations do not need to necessarily be concerned with building and/or maintaining a system, but instead makes use of the service(s) 542 when needed (e.g., on the demand of the users 584A-S). The service(s) 542 may communication with each other and/or with one or more of the user electronic devices 580A-S via one or more Application Programming Interface(s) (APIs) (e.g., a Representational State Transfer (REST) API). The user electronic devices 580A-S are operated by users 584A-S.

In one implementation, the system 540 is a multi-tenant cloud computing architecture supporting multiple services, such as a masking manager, customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 540 may include an application platform 544 that enables PAAS for creating, managing, and executing one or more applications developed by the provider of the application platform 544, users accessing the system 540 via one or more of user electronic devices 580A-S, or third-party application developers accessing the system 540 via one or more of user electronic devices 580A-S.

In some implementations, one or more of the service(s) 542 may utilize one or more multi-tenant databases 546 for tenant data 548, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user electronic device 580A-S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the one or more multi-tenant database 546 and/or system data storage 550.

In some implementations, the service(s) 542 are implemented using virtual applications dynamically created at run time responsive to queries from the user electronic devices 580A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the masking service, may be coded using Procedural Language/Structured Object Query Language (PL/SOQL) that provides a programming language style interface. A detailed description of some PL/SOQL language implementations is discussed in U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 540 and the user electronic devices 580A-S.

Each user electronic device 580A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 540. For example, the user interface device can be used to access data and applications hosted by system 540, and to perform searches on stored data, and otherwise allow a user 584 to interact with various GUI pages that may be presented to a user 584. User electronic devices 580A-S might communicate with system 540 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 580A-S might include an HTTP client, commonly referred to as a “browser,” for sending and receiving HTTP messages to and from server(s) of system 540, thus allowing users 584 of the user electronic device 580A-S to access, process and view information, pages and applications available to it from system 540 over network 582.

### CONCLUSION

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A method for implementing access controls by a masking manager, the method comprising:
receiving a request for an object in a database;
retrieving the object from the database;
applying masking rules to a field of the object to determine whether the requestor has access to the field;
determining a replacement value for the field based on requestor access to the field; and
returning the object to the requestor with the replacement value in the field of the object.

2. The method of claim 1, further comprising:
determining whether the requestor is associated with any masking rules.

3. The method of claim 1, wherein the replacement value is a null or masking value.

4. The method of claim 1, further comprising:
notifying a platform logic of replacing a value of the field.

5. The method of claim 1, further comprising:
determining a classification of the field where the classification indicates a type of masking rule to apply to the field.

6. The method of claim 1, further comprising:
receiving a set of classifications for fields of an object type in the database; and
promulgating the set of classification to the fields of the object type in the database.

7. A non-transitory machine-readable storage medium that provides instructions that, if executed by a processor, will cause said processor to perform operations of a method for implementing access controls by a masking manager, the operations comprising:
receiving a request for an object in a database;
retrieving the object from the database;
applying masking rules to a field of the object to determine whether the requestor has access to the field;
determining a replacement value for the field based on requestor access to the field; and
returning the object to the requestor with the replacement value in the field of the object.

8. The non-transitory machine-readable storage medium of claim 7, the instructions further comprising:
determining whether the requestor is associated with any masking rules.

9. The non-transitory machine-readable storage medium of claim 7, wherein the replacement value is a null or masking value.

10. The non-transitory machine-readable storage medium of claim 7, the instructions further comprising:
notifying a platform logic of replacing a value of the field.

11. The non-transitory machine-readable storage medium of claim 7, the instructions further comprising:
determining a classification of the field where the classification indicates a type of masking rule to apply to the field.

12. The non-transitory machine-readable storage medium of claim 7, the instructions further comprising:
receiving a set of classifications for fields of an object type in the database; and
promulgating the set of classification to the fields of the object type in the database.

13. A computing device to implement a method for access controls by a masking manager, the computing device comprising:
a non-transitory machine-readable medium having stored therein a masking manager; and
a processor coupled to the non-transitory machine-readable medium, the processor to execute the masking manager, the masking manager to receive a request for an object in a database, retrieve the object from the database, apply masking rules to a field of the object to determine whether the requestor has access to the field, determine a replacement value for the field based on requestor access to the field, and return the object to the requestor with the replacement value in the field of the object.

14. The computing device of claim 13, wherein the masking manager is further to determine whether the requestor is associated with any masking rules.

15. The computing device of claim 13, wherein the replacement value is a null or masking value.

16. The computing device of claim 13, wherein the masking manager is further to notify a platform logic of replacing a value of the field.

17. The computing device of claim 13, wherein the masking manager is further to determine a classification of the field where the classification indicates a type of masking rule to apply to the field.

18. The computing device of claim 13, wherein the masking manager is further to receive a set of classifications for fields of an object type in the database, and promulgate the set of classification to the fields of the object type in the database.
